(19) United States
(12) Patent Application Publication
(10) Pub. No.: US 2026/0235997 A1
(43) Pub. Date: Aug. 13, 2026

(54) Development of a Program for Calculating Thermal Ratings of a Power Transformer across Multiple Ambient Temperatures and Operating Conditions

(71) Applicant: Sushanta Paul, Round Rock, TX (US)

(72) Inventor: Sushanta Paul, Round Rock, TX (US)

(21) Appl. No.: 19/048,694

(22) Filed: Feb. 7, 2025

(51) Int. Cl. G05B 15/02

(52) U.S. Cl. CPC G05B 15/02

(57) ABSTRACT

A method and system for batch calculation of transformer thermal ratings across multiple ambient temperatures and operating conditions, based on IEEE Standard C57.91. The program calculates ratings for four conditions—Normal, LTE, STE, and DAL—in a single simulation, significantly reducing computational effort. Users can define temperature ranges and step sizes, enabling the generation of multiple ratings (e.g., 140 ratings for 35 temperatures and 4 conditions) in one run. The invention supports utilities in preparing lookup tables for Ambient Adjusted Ratings (AAR) as required by FERC Order 881, ensuring compliance with regulatory standards. The system can be implemented on standalone or cloud-based platforms for efficient and scalable operation.

### FIELD OF THE INVENTION

The present invention generally relates to the field of power system engineering, specifically to the calculation of transformer thermal ratings. More particularly, the present invention provides a novel C program capable of performing batch calculations of transformer thermal ratings for a wide range of ambient temperatures and multiple operating conditions in a single simulation.

### BACKGROUND OF THE INVENTION

There is a growing need for a new program or method capable of performing batch calculations of transformer thermal ratings for a wide range of ambient temperatures and multiple operating conditions in a single simulation.

Transformer thermal ratings are essential for ensuring the safe and efficient operation of electric utility systems. Traditionally, utilities have calculated these ratings using fixed seasonal ambient temperatures. However, with the issuance of FERC Order 881 in 2021, utilities are now required to adopt a new approach. Specifically, they must implement Ambient Adjusted Ratings (AAR) for their facilities. AAR requires transformer thermal ratings to be calculated dynamically, taking real-time ambient temperature variations into account, and updated at least once every hour. This regulatory change is intended to improve the accuracy of thermal ratings and enhance the efficiency and reliability of transmission systems.

The shift to AAR has introduced significant challenges for utilities. Existing commercial software tools for transformer thermal rating calculations are limited in their capabilities. These tools can only calculate thermal ratings for a single ambient temperature and a single operating condition at a time. As a result, generating ratings for multiple ambient temperatures and operating conditions requires running the software multiple times. This process is inefficient, requiring excessive computational effort and significant time. For example, calculating ratings for 35 ambient temperatures and 4 operating conditions would require 140 separate simulations. This inefficiency creates a major obstacle for utilities and engineering consulting firms that must comply with the requirements of FERC Order 881 within the specified timeframe.

Furthermore, the lack of integrated tools capable of handling dynamic and complex scenarios prevents utilities from optimizing their operations effectively. The repetitive nature of these calculations increases the risk of errors and consumes valuable resources that could be better utilized for other tasks. Thus, there is a need for new methods and systems that can streamline transformer thermal rating calculations, reduce computational effort, and improve accuracy.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention provides a C program (method) specifically designed to calculate transformer thermal ratings across a wide range of ambient temperatures while considering four distinct operating conditions: Normal, Long-Term Emergency (LTE), Short-Term Emergency (STE), and Drastic Action Limit (DAL).

Unlike existing commercial software, which requires separate simulations for each ambient temperature and operating condition, this program performs all calculations in a single simulation, streamlining the process and improving efficiency.

The program enables batch calculations for ambient temperatures by allowing users to define a maximum ambient temperature and a decrement step size. For example, if the maximum ambient temperature is set to 120° F. with a 5° F. decrement, the program calculates ratings for 35 ambient temperatures, ranging from 120° F. to −50° F. This feature eliminates the need for repetitive simulations and manual inputs, significantly reducing the time and effort required for such calculations.

For each ambient temperature, the program simultaneously calculates transformer thermal ratings for all four operating conditions: Normal, LTE, STE, and DAL. This results in 35 ratings for each condition, producing a total of 140 ratings in a single simulation. By consolidating these calculations, the program offers a highly efficient solution compared to existing tools.

The thermal rating calculations are based on the IEEE Standard C57.91, ensuring accuracy and compliance with industry standards. This adherence to established guidelines makes the program reliable and suitable for use in professional and regulatory contexts.

Additionally, the program is designed to support utilities in preparing lookup tables for transformer thermal ratings, a critical requirement for implementing Ambient Adjusted Ratings (AAR) under FERC Order 881. By addressing the challenges of dynamic rating calculations, the program provides an effective and practical solution for utilities working to meet regulatory requirements and improve operational efficiency.

### BRIEF DESCRIPTION OF THE DRAWINGS

FIG. 1 illustrates an online platform in accordance with various embodiments of the present disclosure.

FIG. 2 depicts a block diagram of a system for facilitating operations, consistent with some embodiments.

FIG. 3 provides an illustration of an example method in accordance with one embodiment of the present invention.

FIG. 4 provides an illustration of an example DAL process in accordance with one embodiment of the present invention.

FIG. 5 shows a block diagram of a computing device configured to implement the methods disclosed herein, consistent with some embodiments.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing herefrom, which scope is to be defined by the claims and the equivalents thereof. It is not intended that the scope of patent protection be defined by reading into any claim limitation found herein and/or issuing herefrom that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing herefrom. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of methods, systems, apparatuses, and devices for a C program for batch calculation of transformer thermal ratings across multiple ambient temperatures and operating conditions, embodiments of the present disclosure are not limited to use only in this context.

In general, the method disclosed herein may be performed by one or more computing devices. For example, in some embodiments, the method may be performed by a server computer, a standalone computer, or a distributed computing system. The computing devices may include, but are not limited to, a desktop computer, a laptop computer, a tablet computer, a smartphone, or other computational devices capable of executing the disclosed method. The computing devices may be configured to execute the C program disclosed herein, enabling the batch calculation of transformer thermal ratings across multiple ambient temperatures and operating conditions.

The computing device may include a processing unit configured to execute the algorithm described herein for calculating transformer thermal ratings based on the IEEE Standard C57.91. The processing unit may perform operations such as iterating over a range of ambient temperatures, calculating ratings for multiple operating conditions (Normal, LTE, STE, and DAL), and generating a lookup table of results. The processing unit may also be capable of performing additional data processing tasks such as analyzing, calculating, interpolating, and transforming data related to transformer thermal ratings.

The computing device may further include a storage unit configured to store the input parameters (e.g., maximum and minimum ambient temperatures, decrement step size, transformer specifications) and the output results (e.g., lookup tables of transformer thermal ratings). The storage unit may utilize various data storage technologies to ensure reliable storage and retrieval of information, such as data compression, redundancy, and error correction.

The computing device may also include a communication interface for transmitting and receiving data. For example, the communication interface may enable the device to receive input parameters from external devices, such as a user's computer or a database, and transmit the calculated thermal ratings back to the user or to a central database. The communication interface may support wired or wireless communication channels, such as Ethernet, Wi-Fi, or other communication protocols.

Further, the method disclosed herein may be controlled or initiated by one or more users through a user interface. The user interface may be implemented as a graphical user interface (GUI), a command-line interface, or other input/output mechanisms. Users may input parameters such as the range of ambient temperatures, decrement step size, and transformer specifications, and the interface may display the calculated results in a user-friendly format, such as a table or graph.

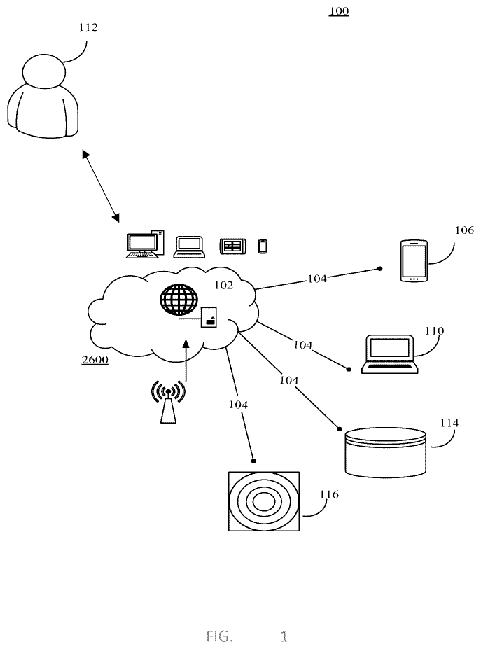

FIG. 1 illustrates an example system 100 consistent with various embodiments of the present disclosure. The system 100 may include a computing device 102, such as a desktop computer, server, or laptop, executing the C program. The computing device 102 may communicate with external devices, such as a database 104 for storing input parameters or results, over a communication network 106, such as the Internet or a local area network. The system may also include user devices 108, such as laptops or smartphones, that allow users to interact with the computing device 102 to input parameters and retrieve results.

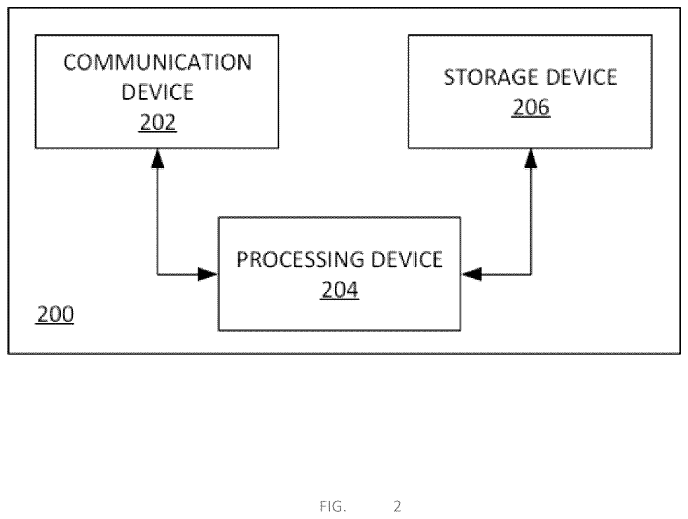

FIG. 2 is a block diagram of a system 200, in accordance with some embodiments of the present disclosure. The system 200 may include a communication device 202, a processing device 204, and a storage device 206. The communication device 202 may be configured to transmit and receive data, such as input parameters and output results, between the system and external devices. The processing device 204 may execute the C program to perform the batch calculation of transformer thermal ratings. The storage device 206 may store the input parameters, intermediate calculations, and final results, such as the lookup table of transformer thermal ratings.

In some embodiments, the method disclosed herein may be integrated into a centralized server or cloud computing platform, enabling multiple users to access the program remotely. For example, utilities and engineering consulting firms may upload transformer specifications and ambient temperature ranges to the platform, and the server may execute the C program to generate thermal ratings. The results may then be downloaded as a lookup table for use in Ambient Adjusted Rating (AAR) implementation, as required by FERC Order 881.

Further, one or more steps of the method disclosed herein may be initiated, maintained, controlled, and/or terminated based on control inputs received from one or more devices operated by users, such as engineers or administrators. The users may access the system through a software application, such as a web-based tool, desktop application, or mobile application. These applications may provide an intuitive interface for inputting parameters, visualizing results, and exporting data.

The present invention provides a novel and efficient method for performing transformer thermal rating calculations, overcoming the limitations of existing commercial software. In one embodiment, the invention enables batch calculations across a wide range of ambient temperatures and multiple operating conditions within a single simulation. This approach significantly reduces computational effort and eliminates the need for repetitive simulations. Furthermore, the invention facilitates compliance with regulatory requirements, such as those mandated by FERC Order 881, by supporting utilities in the preparation of lookup tables for Ambient Adjusted Ratings (AAR) implementation.

The present invention, in one embodiment, provides a method 100 implemented as a C program for performing batch calculations of transformer thermal ratings. This method 100 utilizes an algorithm designed to calculate thermal ratings across a range of ambient temperatures and multiple operating conditions in a single simulation. The algorithm operates based on the following parameters, process, and outputs.

In some embodiments, the method 100 begins with input parameters provided by the user. These parameters include the maximum ambient temperature (e.g., 120° F.), and the step size for decrementing the ambient temperature (e.g., 5° F.). Additional input parameters may include transformer-specific data, such as load, cooling type, and thermal constants, which are necessary for accurate thermal rating calculations.

In one embodiment, the calculation process involves iterating through the specified range of ambient temperatures, decrementing by the defined step size. For each ambient temperature, the program calculates transformer thermal ratings for four distinct operating conditions: Normal, Long-Term Emergency (LTE), Short-Term Emergency (STE), and Drastic Action Limit (DAL). These calculations are performed using thermal rating equations based on the IEEE Standard C57.91, ensuring compliance with industry standards and accuracy in the results.

In some embodiments, the output of the method 100 is a table of transformer thermal ratings. The rows of the table correspond to the range of ambient temperatures, while the columns represent the four operating conditions (Normal, LTE, STE, and DAL). This table can be saved as a lookup table for use in implementing Ambient Adjusted Ratings (AAR) as required by FERC Order 881. For example, in one embodiment, if the maximum ambient temperature is set to 120° F., and the step size is 5° F., the program will calculate ratings for 35 ambient temperatures. For each ambient temperature, it will generate ratings for the four operating conditions, resulting in a total of 140 ratings. This method significantly reduces computational effort and time by consolidating all calculations into a single simulation, making it an efficient and practical solution for utilities and engineering firms.

The present invention offers several advantages that address the challenges associated with transformer thermal rating calculations. One significant advantage is its efficiency. The program consolidates the calculations for multiple ambient temperatures and operating conditions into a single simulation, eliminating the need for separate simulations. For example, instead of running 140 individual simulations, the program performs all calculations in one run, saving considerable time and computational effort. Another advantage of the invention is its ability to facilitate compliance with regulatory requirements. Specifically, the program supports utilities in meeting the requirements of FERC Order 881 by enabling the preparation of lookup tables for Ambient Adjusted Ratings (AAR) implementation. This ensures that utilities can dynamically calculate thermal ratings in accordance with the mandated standards.

The present invention also provides cost savings by automating the batch calculation process. By reducing the time and labor required for transformer thermal rating calculations, the program minimizes operational costs while increasing productivity. This makes it a highly practical solution for utilities and engineering firms. Scalability is another key advantage of the invention. The program is capable of handling a wide range of ambient temperatures and operating conditions, making it adaptable to the diverse needs of utilities. Whether the application involves extreme temperature ranges or multiple operating scenarios, the program can efficiently manage the required calculations.

Finally, the present invention ensures a high degree of accuracy. By utilizing the thermal rating equations outlined in IEEE Standard C57.91, the program produces results that are consistent with industry standards. This reliability in calculations enhances the confidence of utilities in the accuracy of their transformer thermal ratings.

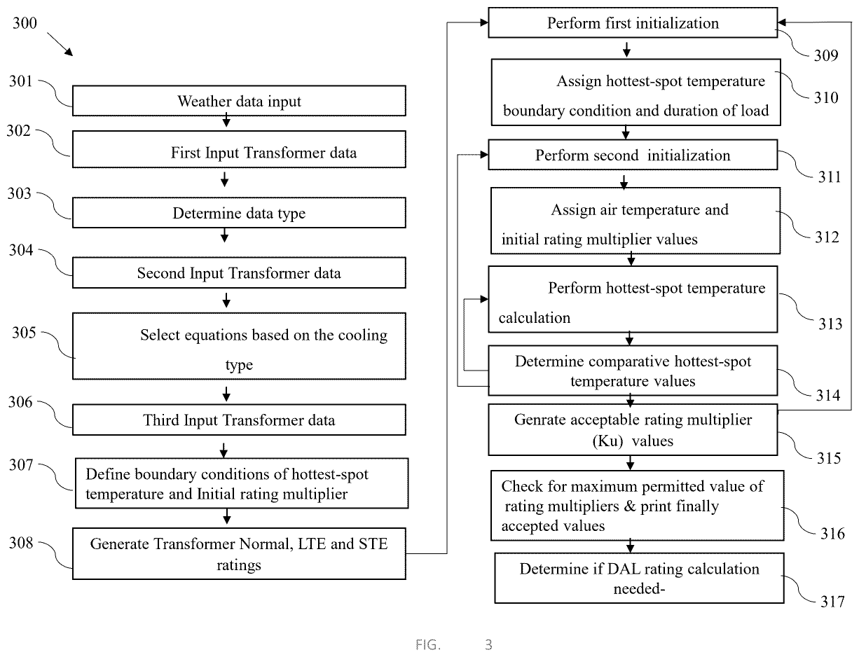

In a preferred embodiment, as shown in FIG. 3, the present invention provides a method 100 comprising the following steps: inputting weather data 301, inputting first transformer data 302, determining the data type 303, inputting second transformer data 304, selecting equations based on the cooling type 305, inputting third transformer data 306, defining boundary conditions of hottest-spot temperature and initial rating multiplier 307, generating transformer Normal, LTE, and STE rating multipliers 308, performing the first initialization 309, assigning hottest-spot temperature boundary condition and duration of load 310, performing the second initialization 311, assigning air temperature and initial rating multiplier 312, performing winding hottest-spot temperature calculation 313, determining comparative hottest-spot temperature values 314, generating acceptable rating multiplier (Ku) values 315, checking for maximum permitted value of rating multipliers & printing finally accepted values 316, and determining if a DAL rating calculation is required 316.

When the method 100 is initiated by a computer program, it may begin the Transformer Thermal Rating Calculations in accordance with IEEE Standard 57.91.

In one embodiment, the present invention provides a method comprising the following steps:

### Input Weather Data 301

In this step, Weather data is entered to account for environmental conditions affecting transformer performance. This includes:
Maximum air temperature (airtempmax).
Decrement interval in air temperature (decre).

### First Input Transformer Data 302

In this step, the cooling type (ctype) is specified to classify the transformer's cooling system. Options may include:
1 for ONAN.
2 for ONAF.
3 for OFAF/OFW.
4 for ODAF/ODWF.

### Determine Data Type 303

Additionally, exponent values for temperature rise equation, can be set based on the selected cooling type. For example:
For ctype=1:

$$n 1 = 0.8$$

$$m = 0. 8$$

For ctype=2:

$$n 1 = 0.9 m = 0.8$$

For ctype=3:

$$n 1 = 0.9 m = 0.8$$

For ctype=4:

$$n 1 = 1 m = 1$$

If the input for cooling type is incorrect, an error message is displayed.

### Second Input Transformer Data 304

Additional transformer-specific parameters can be entered, including:
Enter the top-oil temperature rise (deg C.) over ambient temperature at rated load (ΔΘ_{TO,R})
Enter the winding hottest-spot temperature rise (deg C.) over top-oil temperature at rated (ΔΘ_{H,R})
Enter the total loss (watt) at rated load (P_{T,R})
Enter the ratio of load loss at rated load to no load loss (R)
Enter the ratio of initial load to rated load (Ki)
Enter the weight (pounds) of core and coil assembly (coreoilwt)
Enter the weight (pounds) of tank and fittings (tankwt)
Enter the volume (gallons) of oil (oilvol)

### Select Equations Based on Cooling Type 305

In this step, the cooling type determines the equation used to calculate the thermal capacity (C):
For ctype=1 or ctype=2:

$$C = 0.06 * corecoilwt + 0.04 * tankwt + 1.33 * oilvol .$$

For ctype=3 or ctype=4:

$$C = 0.06 * corecoilwt + 0.06 * tankwt + 1.93 * oilvol .$$

### Third Input Transformer Data 306

In this step, operational data is entered to define the transformer's performance under different conditions:
Enter the winding hottest-spot temperature (deg C.) for normal operation (Θ_{H,NOR})
Enter the duration of load hours for normal operation (tnor)
Enter the winding hottest-spot temperature (deg C.) for LTE operation (Θ_{H,LTE})
Enter the duration of load hour for LTE operation (tLTE)
Enter the winding hottest-spot temperature (deg C.) for STE operation (Θ_{H,STE})
Enter the duration of load hour for STE operation (tSTE)

### Define Boundary Conditions of Hottest-Spot Temperature and Initial Rating Multiplier 307

In this step, lower and upper boundaries of winding hottest-spot temperature and initial value of rating multiplier are defined to calculate the winding hottest-spot temperatures for different operating conditions. Example:

$${Θ}_{H , L 1} = {Θ}_{H , NOR} - 0.5 \\ {Θ}_{H , H 1} = {Θ}_{H , NOR} \\ {Θ}_{H , L 2} = {Θ}_{H , LTE} - 0.5 \\ {Θ}_{H , H 2} = {Θ}_{H , LTE} \\ {Θ}_{H , L 3} = {Θ}_{H , STE} - 0.5 \\ {Θ}_{H , H 3} = {Θ}_{H , STE} \\ Ku 1 = 0.5$$

### Generate Transformer Rating Multipliers 308

In this step, the transformer's Normal, LTE, and STE rating multipliers are generated based on the boundary values of winding hottest-spot temperatures.

### Perform First Initialization 309

In this step, a loop is initialized to iterate through the three operating conditions (Normal, LTE, and STE). The loop is defined as:

$$i = 1 , i <= 3 , i = i + 1 .$$

### Assign Hottest-Spot Temperature Boundary Condition and Duration of Load 310

In this step, for each iteration, the boundary values of hottest-spot temperatures and duration of time for three operating conditions (Normal, LTE, and STE) are assigned
For example:

$${Θ}_{H , L} = {Θ}_{H , L 1} , {Θ}_{H , H} = {Θ}_{H , H 1} , t = tnor , when i = 1 \\ {Θ}_{H , L} = {Θ}_{H , L 2} , {Θ}_{H , H} = {Θ}_{H , H 2} , t = tLTE , when i = 2 \\ {Θ}_{H , L} = {Θ}_{H , L 3} , {Θ}_{H , H} = {Θ}_{H , H 3} , t = tSTE , when i = 3$$

### Perform Second Initialization 311

In this step, a second loop is initialized to iterate through different air temperature conditions. The loop is defined as:

$$n = 1 , n <= 35 , n = n + 1 .$$

### Assign Air Temperature and Initial Rating Multiplier Values 312

In this step, for each iteration, air temperature and the initial rating multiplier (Ku) values are assigned. For example:
For n=1: Ku=Ku1, airtemp=airtemp1.
For n=2: Ku=Ku2, airtemp=airtemp2.
. . .
. . .
For n=35: Ku=Ku35, airtemp=airtemp35.

### Perform Winding Hottest-Spot Temperature Calculation 313

In this step, calculation of winding hottest-spot temperature (Θ_{H}) values are repeated using the updated rating multiplier (Ku) values. Example calculations include:

$$Δ {Θ}_{TO , i} = Δ {Θ}_{TO , R} * {( \frac{{K}_{\text{?}}^{2} + 1}{R + 1} )}^{n 1} \\ Δ {Θ}_{TO , U} = Δ {Θ}_{TO , R} * {( \frac{{K}_{U}^{2} + 1}{R + 1} )}^{n 1} \\ {τ}_{TO , R} = \frac{C * Δ {Θ}_{TO , R}}{{P}_{τ , R}} \\ {τ}_{TO} = {τ}_{TO , R} * \frac{\frac{Δ {Θ}_{TO , U}}{Δ {Θ}_{TO , R}} - \frac{Δ {Θ}_{TO , i}}{Δ {Θ}_{TO , R}}}{{( \frac{Δ {Θ}_{TO , U}}{Δ {Θ}_{TO , R}} )}^{\frac{1}{\text{?}}} - {( \frac{Δ {Θ}_{TO , i}}{Δ {Θ}_{TO , R}} )}^{\frac{1}{\text{?}}}} \\ Δ {Θ}_{TO} = ( Δ {Θ}_{TO , U} - Δ {Θ}_{TO , i} ) * ( 1 - {e}^{\frac{\text{?}}{{τ}_{TO}}} ) + Δ {Θ}_{TO , i} \\ {ΔΘ}_{H} = {ΔΘ}_{HR} * {K}_{U}^{2} \\ {Θ}_{H} = airtemp + Δ {Θ}_{TO} + {ΔΘ}_{H}$$

$$\text{?} \text{indicates text missing or illegible when filed}$$

### Determine Comparative Hottest-Spot Temperature Values 314

In this step, the calculated hottest-spot temperature (Θ_{H}) values are compared to the defined boundary condition:

For ϵ

$${Θ}_{H} > {Θ}_{H , L} \\ \& \\ {Θ}_{H} > {Θ}_{H , H} ,$$

then the values are acceptable.
incremented by 0.001, and the Winding Hottest-spot Temperature Calculation is repeated.

### Generate Acceptable Rating Multiplier (Ku) Values 315

In this step, once acceptable rating multiplier (Ku) values are determined, the corresponding rating multiplier (Ku) values are stored for each operating condition

### (Normal, LTE, and STE).

In some embodiments, the method may include a step to check initialization conditions. In this step, the method checks whether the loops should continue:
If n<=35, the second initialization is repeated.
If i<=3, the first initialization is repeated.

### Check for Maximum Permitted Value of Rating Multipliers 316

In this step, the calculated rating multipliers are compared to maximum permitted value.

For example:
If Ku≤2, then calculated Ku values are finally accepted.
Else Ku=2.

In some embodiments, the method may include a step to print transformer rating multipliers.

In this step, the final results are printed, including:
Normal rating multipliers: K_{U,nor1}, K_{U,nor2}, . . . , K_{U,nor35}.
LTE rating multipliers: K_{U,LTE1}, K_{U,LTE2}, . . . , K_{U,LTE35}.
STE rating multipliers: K_{U,STE1}, K_{U,STE2}, . . . , K_{U,STE35}.

### Determine if DAL Rating Calculation is Needed 316

In this step, the user specifies whether DAL rating calculations are required by entering:
1 for yes.
2 for no.

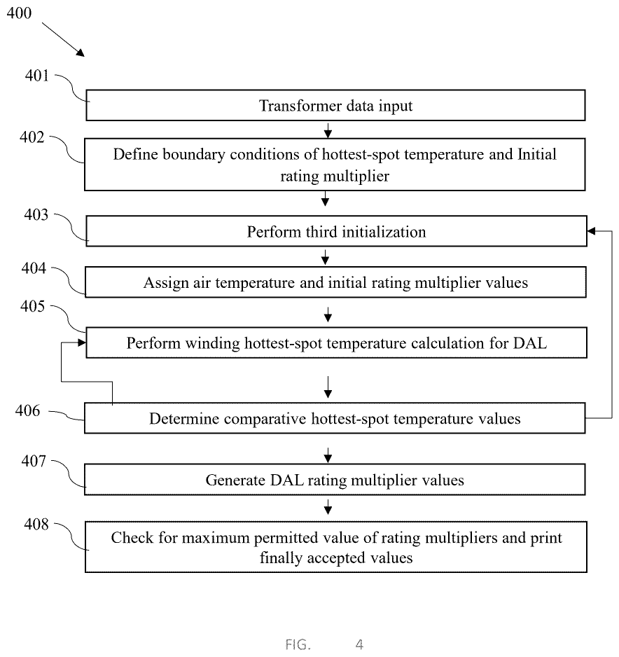

As shown in FIG. 4, the present invention may further include a DAL process 400 for Drastic Action Limit (DAL) operating condition. The DAL process 400 may include following steps:

### Input Transformer Data for DAL 401

In this step, if DAL calculations are required, additional data is entered:
Enter the winding hottest-spot temperature (deg C.) for DAL operation (Θ_{H,DAL})
Enter the duration of load hours for DAL operation (tDAL)

### Define Boundary Conditions of Hottest-spot Temperature and Initial Rating Multiplier 402

In this step, lower and upper boundaries of winding hottest-spot temperature and initial value of rating multiplier are defined. Example:

$${Θ}_{H , L} > {Θ}_{H , DAL} - 0.5 \\ {Θ}_{H , H} > {Θ}_{H , DAL} \\ Ku 1 = 0.5$$

### Perform Third Initialization 403

In this step, relevant values can be initiated. For example: n=1, n<=35, n=n+1

### Assign Air Temperature and Initial Rating Multiplier Values 404

In this step, for each iteration, air temperature and initial rating multiplier (Ku) values are assigned. Example:
For n=1: Ku=Ku1, airtemp=airtemp1.
For n=2: Ku=Ku1, airtemp=airtemp2.
. . .
. . .
For n=35: Ku=Ku1, airtemp=airtemp35.

### Perform Winding Hottest-Spot Temperature Calculation for DAL 405

In this step, calculation of winding hottest-spot temperature values for DAL operation are repeated using the updated rating multiplier (Ku) values. Example calculations include:

$$Δ {Θ}_{TO , i} = Δ {Θ}_{TO , R} * {( \frac{{K}_{\text{?}}^{2} + 1}{R + 1} )}^{n 1} \\ Δ {Θ}_{TO , U} = Δ {Θ}_{TO , R} * {( \frac{{K}_{U}^{2} + 1}{R + 1} )}^{n 1} \\ {τ}_{TO , R} = \frac{C * Δ {Θ}_{TO , R}}{{P}_{τ , R}} \\ {τ}_{TO} = {τ}_{TO , R} * \frac{\frac{Δ {Θ}_{TO , U}}{Δ {Θ}_{TO , R}} - \frac{Δ {Θ}_{TO , i}}{Δ {Θ}_{TO , R}}}{{( \frac{Δ {Θ}_{TO , U}}{Δ {Θ}_{TO , R}} )}^{\frac{1}{\text{?}}} - {( \frac{Δ {Θ}_{TO , i}}{Δ {Θ}_{TO , R}} )}^{\frac{1}{\text{?}}}} \\ Δ {Θ}_{TO} = ( Δ {Θ}_{TO , U} - Δ {Θ}_{TO , i} ) * ( 1 - {e}^{\frac{\text{?}}{{τ}_{TO}}} ) + Δ {Θ}_{TO , i} \\ {ΔΘ}_{H} = {ΔΘ}_{HR} * {K}_{U}^{2} \\ {Θ}_{H} = airtemp + Δ {Θ}_{TO} + {ΔΘ}_{H}$$

$$\text{?} \text{indicates text missing or illegible when filed}$$

### Determine Comparative Hottest-Spot Temperature Values for DAL 406

In this step, the calculated hottest-spot temperature (Θ_{H}) values are compared to the defined boundary condition.

For ϵ

$${Θ}_{H} > {Θ}_{H , L} \\ \& \\ {Θ}_{H} > {Θ}_{H , H} ,$$

then the values are acceptable.
incremented by 0.001, and the Winding Hottest-spot Temperature Calculation for DAL is repeated.

### Generate Acceptable DAL Rating Multipliers 407

In this step, the DAL rating multipliers are determined and corresponding rating multiplier (Ku) and other values are stored as:

$${K}_{U , DAL 1} = {K}_{U} , {ΔΘ}_{TO , iDAL 1} = {ΔΘ}_{T O , i} , \\ {ΔΘ}_{T O , UDAL 1} = {ΔΘ}_{T O , U} , {ΔΘ}_{H , DAL 1} = {ΔΘ}_{H} , {τ}_{τ o , DAL 2} = {T}_{T O} \\ when n = 1 \\ {K}_{U , DAL 2} = {K}_{U} , {ΔΘ}_{TO , iDAL 2} = {ΔΘ}_{T O , i} , \\ {ΔΘ}_{T O , UDAL 2} = {ΔΘ}_{T O , U} , {ΔΘ}_{H , DAL 2} = {ΔΘ}_{H} , {τ}_{τ o , DAL 2} = {T}_{To} \\ when n = 2 \\ {K}_{U , D A L 35} = {K}_{U} , {ΔΘ}_{TO , iDAL 35} = {ΔΘ}_{T O , i} , \\ {ΔΘ}_{T O , U D A L 35} = {ΔΘ}_{T O , U} , {ΔΘ}_{H , D A L 35} = {ΔΘ}_{H} , {τ}_{T O , D A L 35} = {T}_{T o} \\ when n = 35$$

In one embodiment, the values can be verified. For example, if <=35, the process is repeated.

### Check for Maximum Permitted Value of Rating Multipliers 408

In this step, the calculated rating multipliers are compared to maximum permitted value. For example:
If Ku≤2, then calculated Ku values are finally accepted.
Else Ku=2.

In some embodiments, the method may include a step to print transformer rating multipliers.

In this step, the final results are printed, including:
DAL rating multipliers: K_{U,DAL1}, K_{U,DAL2}, . . . , K_{U,DAL35}.

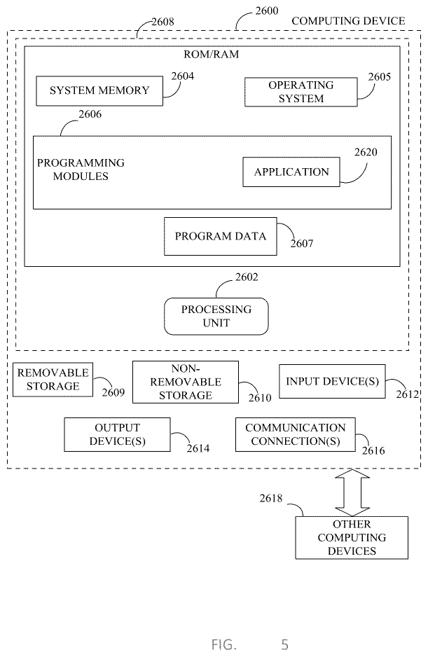

With reference to FIG. 5, a system consistent with an embodiment of the disclosure may include a computing device or cloud service, such as computing device 2600. In a basic configuration, computing device 2600 may include at least one processing unit 2602 and a system memory 2604. Depending on the configuration and type of computing device, system memory 2604 may comprise, but is not limited to, volatile memory (e.g., random-access memory (RAM)), non-volatile memory (e.g., read-only memory (ROM)), flash memory, or any combination thereof. System memory 2604 may include an operating system 2605, one or more programming modules 2606, and program data 2607. For example, operating system 2605 may be suitable for controlling the operation of computing device 2600. In one embodiment, programming modules 2606 may include the C program disclosed herein for batch calculation of transformer thermal ratings. Furthermore, embodiments of the disclosure may be practiced in conjunction with other operating systems, libraries, or application programs and are not limited to any particular system or configuration. This basic configuration is illustrated in FIG. 5 by the components within dashed line 2608.

Computing device 2600 may have additional features or functionality. For example, computing device 2600 may also include additional data storage devices (removable and/or non-removable), such as magnetic disks, optical disks, or solid-state drives. Such additional storage is illustrated in FIG. 5 by removable storage 2609 and non-removable storage 2610. Computer storage media may include volatile and non-volatile, removable and non-removable media implemented in any method or technology for storing information, such as computer-readable instructions, data structures, program modules, or other data. Examples of computer storage media include, but are not limited to, RAM, ROM, electrically erasable programmable read-only memory (EEPROM), flash memory, CD-ROM, digital versatile disks (DVD), magnetic cassettes, magnetic tape, magnetic disk storage, or any other medium that can store information and be accessed by computing device 2600. Any such computer storage media may be part of computing device 2600.

Computing device 2600 may also include input device(s) 2612, such as a keyboard, mouse, pen, sound input device, touch input device, location sensor, or biometric sensor. Output device(s) 2614, such as a display, speakers, or printer, may also be included. These input and output devices allow users to interact with the C program for inputting parameters (e.g., ambient temperature range, decrement step size, transformer specifications) and viewing the calculated transformer thermal ratings. The aforementioned devices are examples, and others may be used.

Computing device 2600 may also contain a communication connection 2616 that allows device 2600 to communicate with other computing devices 2618, such as over a network in a distributed computing environment, for example, an intranet or the Internet. Communication connection 2616 is one example of communication media. Communication media may include computer-readable instructions, data structures, program modules, or other data in a modulated data signal, such as a carrier wave or other transport mechanism, and includes any information delivery media. By way of example, and not limitation, communication media may include wired media, such as a wired network or direct-wired connection, and wireless media, such as acoustic, radio frequency (RF), infrared, and other wireless media. The term “computer-readable media” as used herein may include both storage media and communication media.

As stated above, a number of program modules and data files may be stored in system memory 2604, including operating system 2605. While executing on processing unit 2602, programming modules 2606 may perform processes such as the batch calculation of transformer thermal ratings, including iterating over a range of ambient temperatures, calculating ratings for multiple operating conditions (Normal, LTE, STE, and DAL), and generating a lookup table of results. The aforementioned process is an example, and processing unit 2602 may perform other processes related to transformer thermal rating calculations. Other programming modules that may be used in accordance with embodiments of the present disclosure may include data analysis modules, visualization tools, or machine learning applications for predictive modeling of transformer performance.

Generally, consistent with embodiments of the disclosure, program modules may include routines, programs, components, data structures, and other types of structures that perform particular tasks or implement particular abstract data types. Moreover, embodiments of the disclosure may be practiced with other computer system configurations, including hand-held devices, general-purpose computers, multiprocessor systems, microprocessor-based or programmable consumer electronics, application-specific integrated circuits, and the like. Embodiments of the disclosure may also be practiced in distributed computing environments where tasks are performed by remote processing devices linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations, such as AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list) include an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices like hard disks, solid-state storage (e.g., USB drives), or CD-ROMs, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method, comprising:
inputting weather data;
inputting first transformer data input, specifying cooling types;
setting exponent values for temperature rise equation based on the cooling types, displaying an error message if the cooling types are incorrect;
inputting second transformer data, specifying transformer-specific parameters;
selecting equations based on the cooling type to calculate a thermal capacity;
inputting operational data;
defining boundary conditions of hottest-spot temperature and initial rating multiplier to determine winding hottest-spot temperatures for different operating conditions,
generating transformer ratings multipliers for normal, LTE, and STE operations based on defined boundary conditions of hottest-spot temperature;
performing a first initialization, wherein a loop is initialized to iterate through the three operating conditions (Normal, LTE, and STE);
assigning hottest-spot temperature boundary condition and duration of load wherein for each iteration, the hottest-spot temperature values are recalculated based on the operating condition;
performing a second initialization, wherein a loop is initialized to iterate through different air temperature conditions;
assigning air temperature and initial rating multiplier for each iteration,
performing winding hottest-spot temperature calculation, wherein the winding hottest-spot temperature values are recalculated using the updated load multiplier (Ku) values,
determining comparative winding hottest-spot temperature values by verifying that the calculated winding hottest-spot temperature satisfies the boundary condition:
adjusting the load multiplier if the calculated winding hottest-spot temperature values fall outside the acceptable range, wherein Ku is incremented by 0.001 and the calculations are repeated;
generating acceptable Ku values for each operating condition (Normal, LTE, and STE);
checking for maximum permitted value of load multipliers; and
outputting transformer thermal rating multipliers for normal, LTE, and STE operations.

2. The method of claim 1, further comprising:
determining whether a Drastic Action Limit (DAL) rating calculation is required.

3. The method of claim 2, wherein if the determining requires Load (DAL) rating calculation, performing a first DAL input, wherein additional transformer data is entered.

4. The method of claim 3, wherein the additional transformer data includes
a winding hottest-spot temperature; and
duration of load hours.

5. The method of claim 4, further comprising performing a first DAL calculation.

6. The method of claim 5, further comprising performing a second DAL calculation.

7. The method of claim 5, further comprising
determining comparative hottest-spot temperature values for DAL by verifying that the calculated hottest-spot temperature values fall within the defined boundary condition.

8. The method of claim 5, further comprising generating acceptable Ku values for DAL operation; and outputting DAL rating multipliers.

9. The method of claim 1, wherein the second initialization is repeated until the condition n<=35 is satisfied.

10. A method, comprising:
inputting weather data;
inputting first transformer data input, specifying cooling types;
setting exponent values for temperature rise equation based on the cooling types;
inputting second transformer data, specifying transformer-specific parameters;
selecting equations based on the cooling type to calculate a thermal capacity;
inputting operational data;
defining boundary condition of hottest-spot temperature and initial rating multiplier to determine winding hottest-spot temperatures for different operating conditions,
generating transformer rating multipliers;
performing a first initialization;
assigning hottest-spot temperature boundary condition and duration of load;
performing a second initialization; assigning air temperature and initial rating multiplier for each iteration,
performing winding hottest-spot temperature calculation, wherein the winding hottest-spot temperature values are recalculated using the updated load multiplier (Ku) values,
determining comparative winding hottest-spot temperature values by verifying that the calculated winding hottest-spot temperature satisfies the boundary condition:
adjusting the load multiplier, if the calculated winding hottest-spot temperature values fall outside the defined boundary condition, Ku is incremented by 0.001 and winding hottest-spot temperature calculations are repeated;
generating acceptable Ku values for each operating condition;
checking for maximum permitted value of load multipliers; and
outputting transformer thermal rating multipliers.

11. The method of claim 10, further comprising:
determining whether a Drastic Action Limit (DAL) rating calculation is required.

12. The method of claim 11, wherein if the determining requires Load (DAL) rating calculation, performing a first DAL input, wherein additional transformer data is entered.

13. A system, comprising:
memory including machine-readable instructions; and
one or more processors configured, in response to executing the machine-readable instructions, to perform operations comprising:
inputting weather data;
inputting first transformer data input, specifying cooling types;
setting specific exponent values for temperature rise equation based on the cooling types, displaying an error message if the cooling types are incorrect;
inputting second transformer data, specifying transformer-specific parameters;
selecting equations based on the cooling type to calculate a thermal capacity;
inputting operational data;
defining boundary condition of hottest-spot temperature and initial rating multiplier to determine winding hottest-spot temperatures for different operating conditions,
generating transformer ratings for normal, LTE, and STE operations based on defined boundary conditions of hottest-spot temperature;
performing a first initialization, wherein a loop is initialized to iterate through the three operating conditions (Normal, LTE, and STE);
assigning hottest-spot temperature boundary condition and duration of load wherein for each iteration, the hottest-spot temperature values are recalculated based on the operating condition;
performing a second initialization, wherein a loop is initialized to iterate through different air temperature conditions;
assigning air temperature and initial rating multiplier for each iteration,
performing winding hottest-spot temperature calculation, wherein the winding hottest-spot temperature values are recalculated using the updated load multiplier (Ku) values,
determining comparative winding hottest-spot temperature values by verifying that the calculated winding hottest-spot temperature satisfies the boundary condition:
adjusting the load multiplier if the calculated winding hottest-spot temperature values fall outside the defined boundary condition, wherein Ku is incremented by 0.001 and the calculations are repeated;
generating acceptable Ku values for each operating condition (Normal, LTE, and STE);
checking for maximum permitted value of load multipliers; and
outputting transformer thermal rating multipliers for normal, LTE, and STE operations.

14. The system of claim 13, further comprising:
determining whether a Drastic Action Limit (DAL) rating calculation is required.

15. The system of claim 14, wherein if the determining requires Load (DAL) rating calculation, performing a first DAL input, wherein additional transformer data is entered.

16. The system of claim 15, wherein the additional transformer data includes
a winding hottest-spot temperature; and
duration of load hours.

17. The method of claim 16, further comprising
performing a first DAL calculation and a second DAL calculation.

18. The method of claim 17, further comprising
determining comparative hottest-spot temperature values for DAL by verifying that the calculated hottest-spot temperature values fall within the defined boundary condition.

19. The method of claim 18, further comprising generating acceptable Ku values for DAL operation; and outputting DAL rating multipliers.

20. The method of claim 13, wherein the second initialization is repeated until the condition n<=35 is satisfied.
